(19) United States
(12) Patent Application Publication
(10) Pub. No.: US 2014/0222482 A1
(43) Pub. Date: Aug. 7, 2014

(54) ONLINE APPOINTMENT SCHEDULERS

(71) Applicant: WAL-MART STORES, INC., Bentonville, AR (US)

(72) Inventors: Ajay Kumar Gautam, Bentonville, AR (US); Madhu Gautam, Bentonville, AR (US); Suyash Kotpalliwar, Rogers, AR (US); Vivek Sharma, Bentonville, AR (US)

(73) Assignee: WAL-MART STORES, INC., Bentonville, AR (US)

(21) Appl. No.: 13/759,599

(22) Filed: Feb. 5, 2013

(51) Int. Cl. G06Q 10/10

(52) U.S. Cl. CPC G06Q 10/1095
USPC 705/7.19

(57) ABSTRACT

Provided is are a system and method for online appointment scheduling. A central online application presented at an electronic display is searched for a store location of a plurality of store locations The plurality of store locations are part of a retail establishment that presents information related to the store locations from the central online application. The store location is selected. An appointment scheduler processes an appointment scheduling request corresponding to the store location that is submitted to the central online application. A response to the appointment scheduling request is generated.

### FIELD OF THE INVENTION

Embodiments of the present inventive concepts relate to appointment schedulers, and more particularly to systems and methods for online appointment scheduling.

### BACKGROUND

People can use the Internet for many different purposes. One popular use is to access a store's website before physically visiting the store. Retail establishments, in particular, large stores, shopping plazas, and malls, may have many different departments or other organizational structures, typically have a main website, or homepage, which includes links to specific store locations, or departments at the store location, or product or service-specific regions of a store. Once a user navigates to a webpage corresponding to a store location, the user can peruse information specific service offerings, for example, store hours, phone numbers, etc.

### SUMMARY

In one aspect, provided is a method for online appointment scheduling. A search is performed at a central online application presented at an electronic display for a store location of a plurality of store locations, wherein the plurality of store locations are part of a retail establishment that presents information related to the store locations from the central online application. Selected at the central online application of the electronic display is the store location. An appointment scheduler in communication with the central online application processes an appointment scheduling request corresponding to the store location that is submitted to the central online application. A response to the appointment scheduling request is generated.

In another aspect, provided is an online appointment scheduler, comprising a processor that communicates with a central online application presented at an electronic display and that processes an appointment scheduling request corresponding to a store location of a plurality of store locations that are part of a retail establishment; and a processor that generates a response to the appointment scheduling request.

In another aspect, provided is a computer program product for online appointment scheduling. The computer program product comprises a computer readable storage medium having computer readable program code embodied therewith. The computer readable program code comprises computer readable program code configured to search, at a central online application presented at an electronic display, for a store location of a plurality of store locations, wherein the plurality of store locations are part of a retail establishment that presents information related to the store locations from the central online application; computer readable program code configured to process an appointment scheduling request corresponding to the store location that is submitted to the central online application; and computer readable program code configured to generate a response to the appointment scheduling request.

### BRIEF DESCRIPTION OF THE DRAWINGS

The foregoing and other features and advantages of the inventive concepts will be apparent from the more particular description of preferred embodiments of the inventive concepts, as illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is a block diagram illustrating an environment in which embodiments of the present inventive concepts can be practiced;

FIG. 2 is a block diagram illustrating relationships between various elements of an online appointment scheduling application, in accordance with an embodiment;

FIG. 3 is a method for online appointment scheduling, in accordance with an embodiment;

FIG. 4 is a method for online appointment scheduling, in accordance with another embodiment;

FIG. 5 is a method for processing an appointment request, in accordance with an embodiment;

FIG. 6A is a screenshot of a homepage of a retail corporation, in accordance with an embodiment;

FIG. 6B is a screenshot of an appointment scheduler presented in response to a selection of an appointment schedule button from the homepage of FIG. 6A, in accordance with an embodiment;

FIG. 6C is a screenshot of a set of appointment scheduling windows presented in response to a selection of a store from the appointment scheduler of FIG. 6B, in accordance with an embodiment;

FIG. 6D is a screenshot of a new user registration screen, in accordance with an embodiment;

FIG. 6E is a screenshot of an appointment confirmation presented to a user requesting the appointment, in accordance with an embodiment;

FIG. 6F is a screenshot of an email message presented to a party that includes a request for the party to accept or deny a confirmation request made by a user scheduling an appointment with the party, in accordance with an embodiment;

FIG. 6G is a screenshot of an email message presented to a user scheduling an appointment that confirms the scheduling of the appointment by the user, in accordance with an embodiment;

FIG. 6H is a screenshot of an appointment scheduling request response window, in accordance with an embodiment;

FIG. 6I is a screenshot of a scheduling manager, in accordance with an embodiment; and

FIG. 6J is a screenshot of an email message including appointment confirmation information, in accordance with an embodiment.

### DETAILED DESCRIPTION OF THE EMBODIMENTS

In the following description, specific details are set forth although it should be appreciated by one of ordinary skill that the systems and methods can be practiced without at least some of the details. In some instances, known features or processes are not described in detail so as not to obscure the present invention.

Although a store's website may include links to store locations, divisions, departments, etc., online users may desire to schedule appointments with the various divisions before they visit the physical location, and to avoid the oftentimes frustration such as long waiting lines experienced by walk-ins.

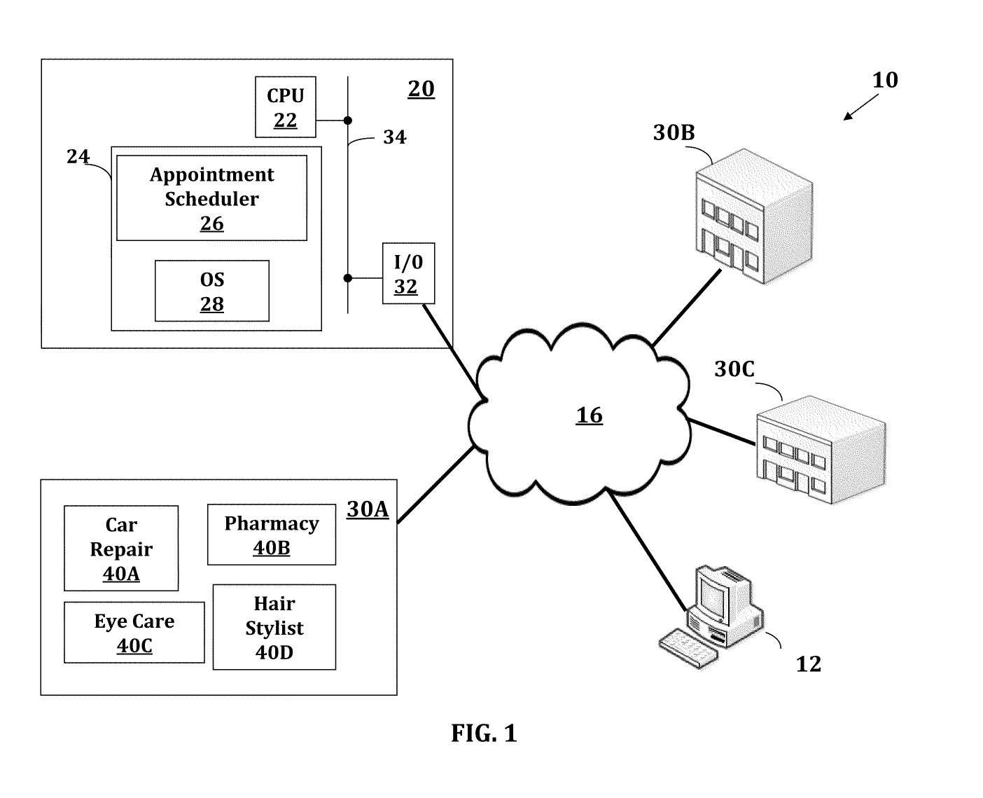

FIG. 1 is a block diagram illustrating an environment 10 in which embodiments of the present inventive concepts can be practiced.

The environment 10 permits an exchange of data to occur between a user electronic device 12, such as a desktop, a laptop, a smartphone, or other computer, and a retail establishment's various websites distributed at one or more different locations 30A, 30B, 30C (generally, 30) via a network 16. The locations 30A, 30B, 30C can each refer to a physical store location having computer resources for provide website or related e-commerce features for Internet users. Alternatively, each store website can be co-located under one or more servers at a single location. Each store location 30A, 30B, 30C can provide common products and services, for example, a hair salon. Some store locations may offer different products and services than other locations. For example, store location 30A may include a car repair center 40A, while store locations 30B and 30C do not have a car repair center. Some store locations may share a same website. Some or all locations may have different websites that are linked to a central website. In this manner, a computer user can enter the central website to gather general information about the retail establishment's offerings, and enter the website of a store location 30 for store-specific information.

The store locations 30 include computer servers, network devices, and/or other electronic components that provide electronic communication with a computer system 20 via the network 16. The store locations 30 can be part of a superstore, a mall, or other large entity at a single location, or can be individual entities, for example, franchisees, outlet stores, or the like, at various locations under the management of a large entity. The network 16 can include a public switched telephone network (PSTN), a mobile communications network, a data network, such as a local area network (LAN) or wide area network (WAN), or a combination thereof, or other communication network known to those of ordinary skill in the art.

One or more store locations can be organized to include one or more departments, for example, a service center department, or other product or service-based arrangement, or sub-organization. For example, as shown in FIG. 1, store location 30A includes, but is not limited to, a car repair center 40A, a pharmacy 40B, an eye care center 40C, and a hair stylist 40D, generally referred to as service areas 40. Other examples of a service area 40 can include electronics stores, restaurants, jewelry centers, tailoring centers, photography stores, and so on. One or more service areas 40 may accept walk-in customers, and/or schedule appointments for customers who prefer to be received at a scheduled time.

The computer system 20 can include a processor 22 such as a central processing unit (CPU), a memory 24, and an input/output (I/O) logic 32, which can communicate with each other via a bus 34, for example, a peripheral component interconnect (PCI) bus. The I/O logic 32 can include a network interface card (NIC) or other adaptor for connecting the computer system 20 with the network 16. The computer system 20 can be positioned at a store location 30, a corporate location, for example, a company headquarters, or a remote location, for example, a service provider that hosts a store's website.

The memory 24 can include volatile memory, for example, random access memory (RAM) and the like, and/or non-volatile memory, for example, read-only memory (ROM), flash memory, and the like. The memory 24 can include removable and/or non-removable storage media implemented in accordance with methods and technologies known to those of ordinary skill in the art for storing data. Stored in the memory 24 can include program code, such as program code of an operating system (OS) 28 and an appointment scheduler 26 executed by the processor 22. In an embodiment, program code for a store website is co-located with the appointment scheduler 26 at the memory 24.

In an embodiment, the appointment scheduler 26 is constructed and arranged to permit an online visitor to a store website to schedule, reschedule, and/or cancel appointments at a service area 40. The appointment scheduler 26 can generate a confirmation email, text message, or other electronic communication that can be sent to the website visitor. In an embodiment, the appointment scheduler 26 does not require special access, for example, a user account with the store. Accordingly, a friend, family member, or other relation to a person interested in a service (e.g., haircut) can make the appointment on the person's behalf.

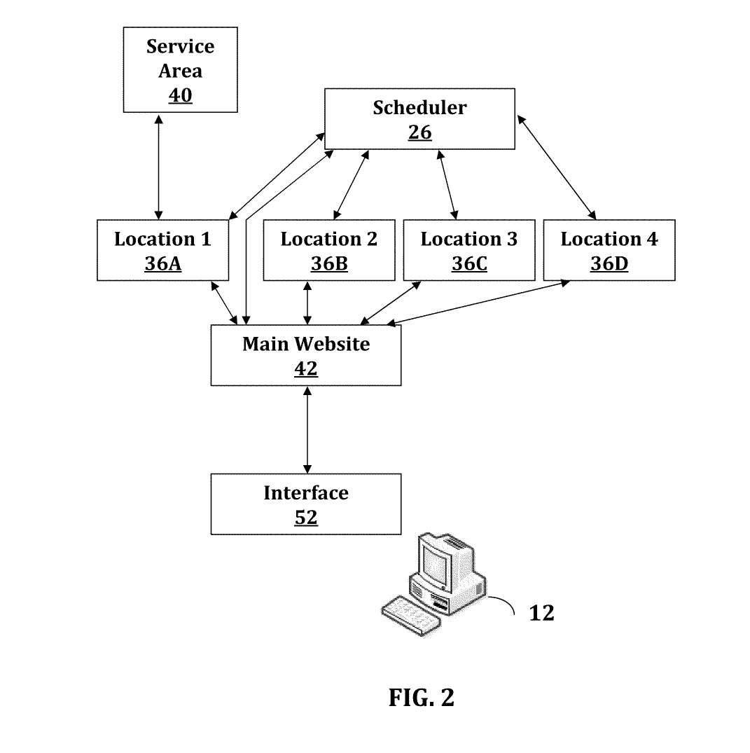

FIG. 2 is a block diagram illustrating relationships between various elements of an online appointment scheduling application, in accordance with an embodiment. In describing the elements of FIG. 2, reference is made to FIG. 1.

A user at a computer 12 can view a store's main website 42 from an interface 52, for example, a computer user interface that presents the website contents on a computer display such as a desktop computer monitor or a mobile device touchscreen. Although embodiments herein refer to the visual display of information, for example, websites, scheduling applications, and so on, such information can be communicated in forms other than by a visual display, for example, via audio.

The main website 42 can include links to specific store location websites 36A-36D (generally, 36). A store location website 36 can display, or otherwise communicate information, for example, via speech instead of visual display, related to one or more service areas 40 at the store location 30, for example, store hours, location information, product and/or service offerings, and so on. The information at the store location websites 36 can be retrieved from a storage device, for example, having a database, and displayed to the computer user 12 via the interface 52.

The appointment scheduler 26 is constructed and arranged to allow the user 12 to schedule, reschedule, and/or cancel an appointment at any of the service areas 40 online via the main website 42 and/or the store location websites 36. The appointment scheduler 26 can generate messages indicating whether an appointment schedule request is granted. The appointment scheduler 26 can be on a computer at a corporate location, such as a company headquarters or a hosted service provider location. Alternately, some or all elements of the appointment scheduler 26 can be on computers located at one or more store locations 30. For example, the appointment scheduler 26 can include an appointment processing application, which receives and processes user requests for appointments, at one or more computers, for example, corresponding to a service area 40 at store location 30 where the appointment is to be made.

The appointment scheduler 26 can be part of, or otherwise in communication with, the main website 42, which provides information for some or all stores under a retail establishment, e.g., a corporate headquarters. For example, the appointment scheduler 26 can be integrated into an existing website, such as the main website 42, and/or a website of a particular store location. Regardless of whether the appointment is separate from or integrated with the website 42, the appointment scheduler 26 includes a processor that communicates with the website to process appointment scheduling requests.

The appointment scheduler 26 can be constructed and arranged to process appointment scheduling requests for all divisions, service centers, or other sub-organizations at a single store location, for example, all divisions under a supercenter. Referring to FIG. 1, the appointment scheduler 26 can process all requests for appointments at the car repair center 40A, the pharmacy 40B, the eye care center 40C, and the hair stylist 40D, as distinguished from requiring a unique scheduler for each of these service areas 40A-40D.

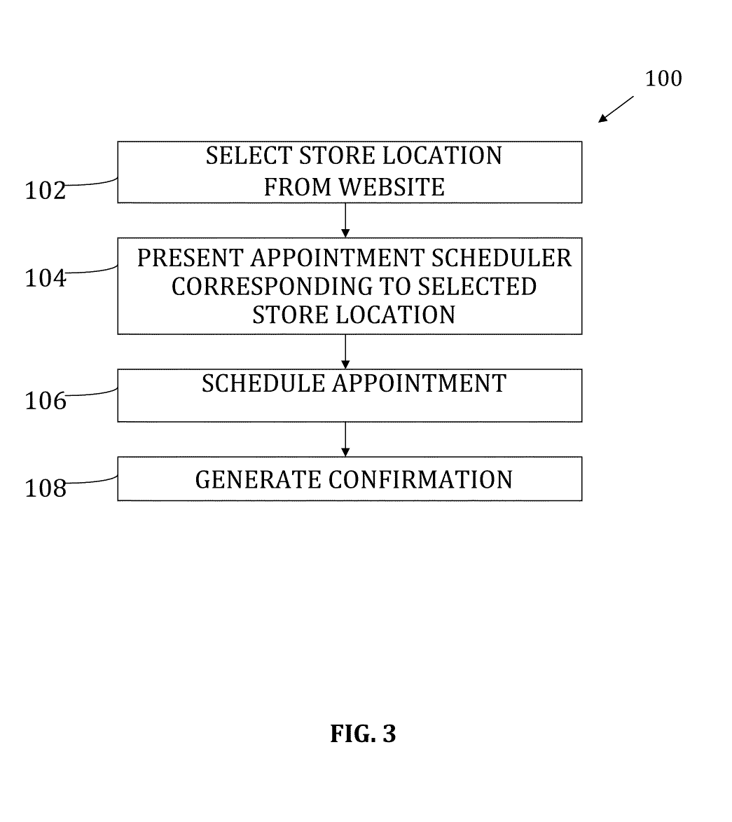

FIG. 3 is a method 100 for online appointment scheduling, in accordance with an embodiment. In describing the method 100, reference is made to FIGS. 1 and 2. Some or all of the method 100 can be performed at the computer system 20, a user electronic device 12, and/or computers at the store locations 30, for example, governed by instructions that are stored in the memory 24 of the computer system 20 and executed by a processor 22 of the computer system 20.

At block 102, a store location is selected from a website. The website can be a main website for a company, mall, franchise, or other business entity having several different stores, offices, departments, branches, divisions, product or service area, regions, or other sub-organizations at various locations. The main website can include links to other websites, web pages, or the like for each of its different stores, offices, or other sub-entities.

At block 104, the appointment scheduler 26 can present a scheduling window at the user interface 52 so that a computer user 12 can enter appointment information corresponding to a particular store location 30, or more specifically, a department, branch, or other sub-entity such as a service area 40 at a store location 30.

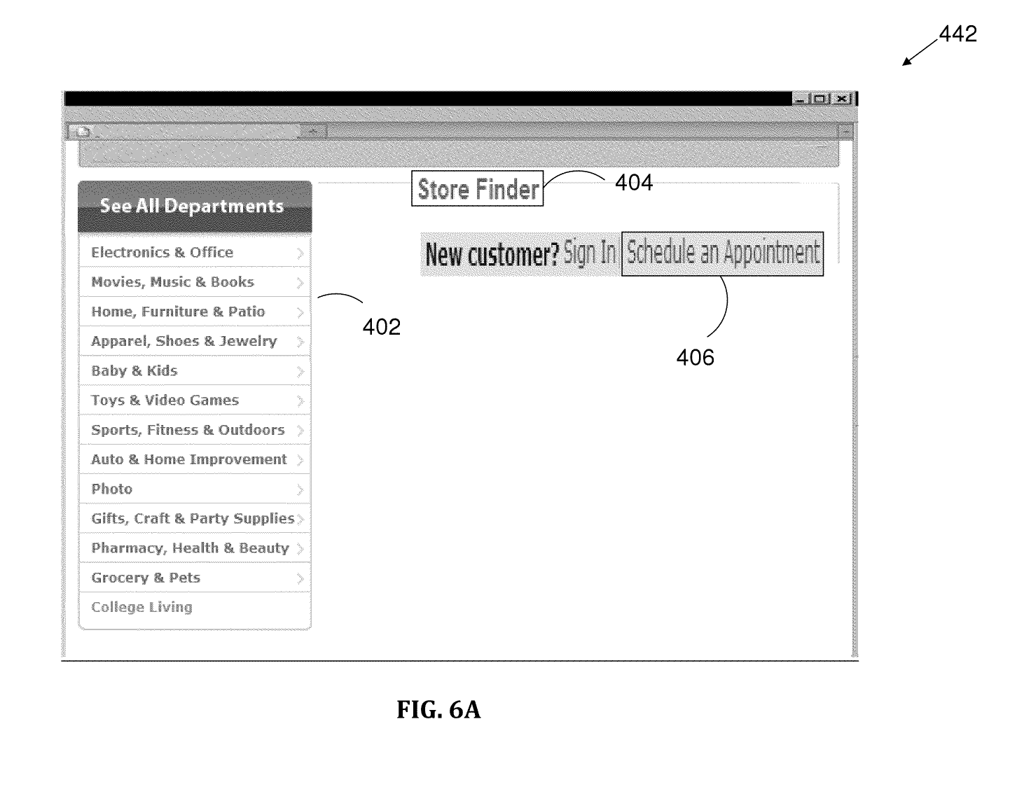

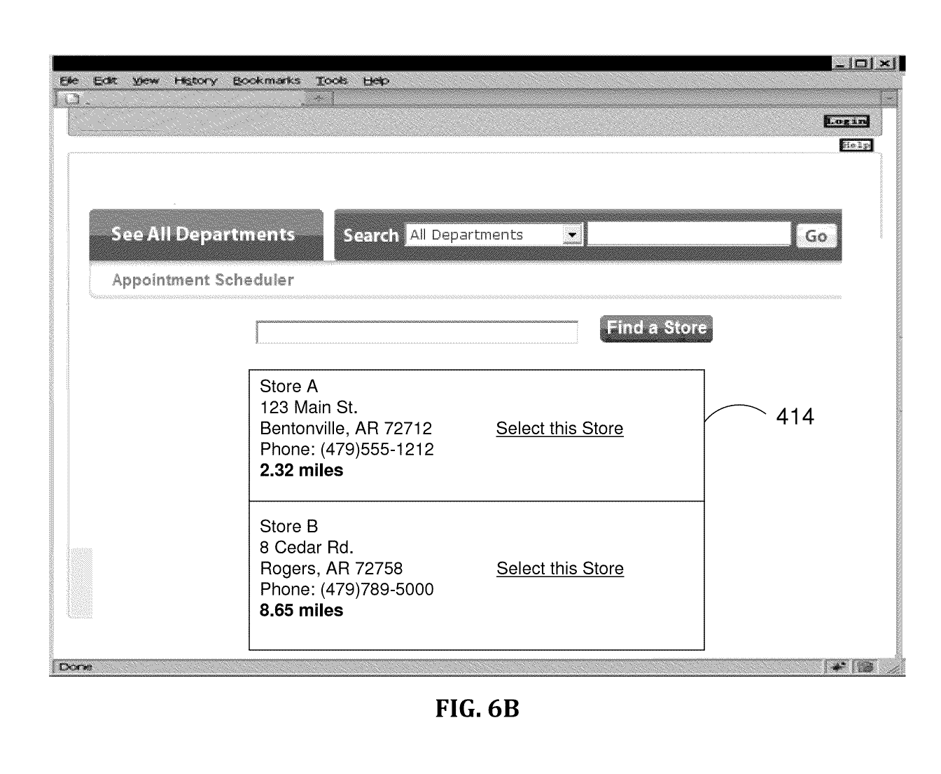

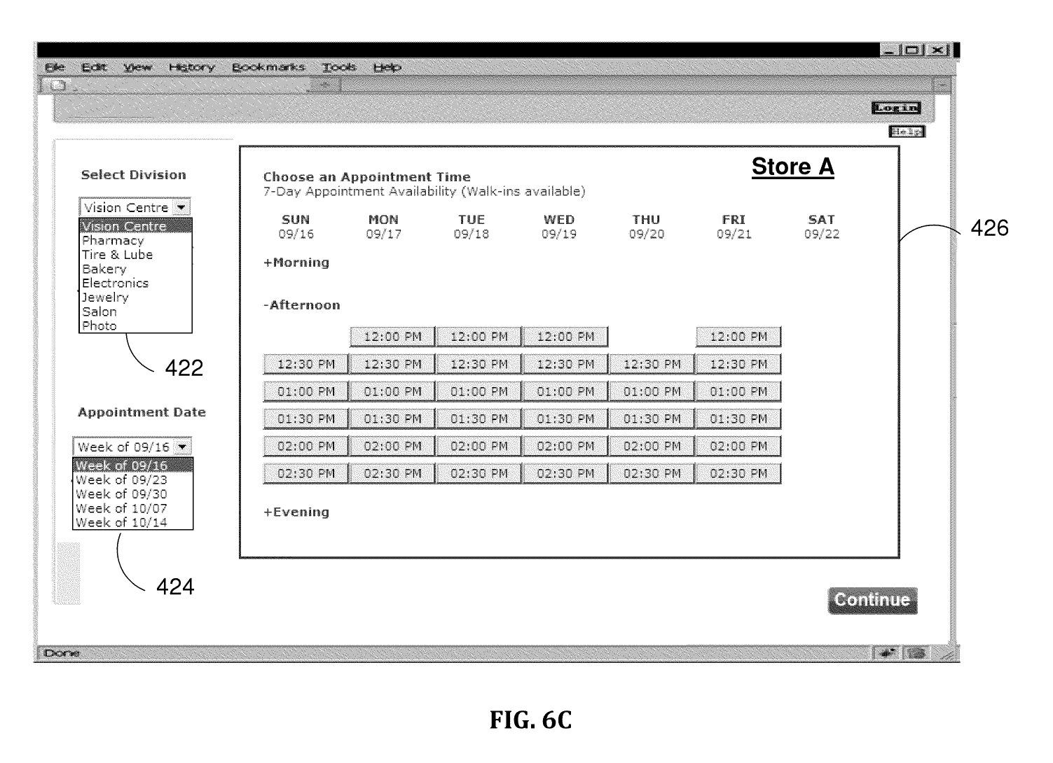

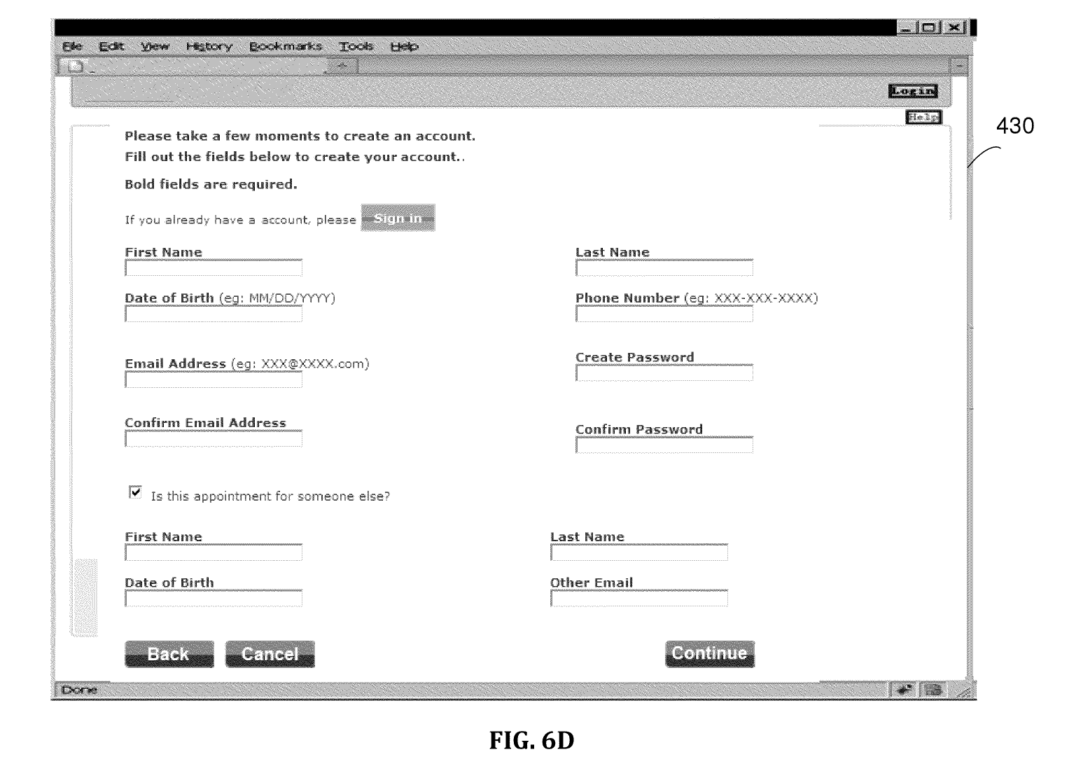

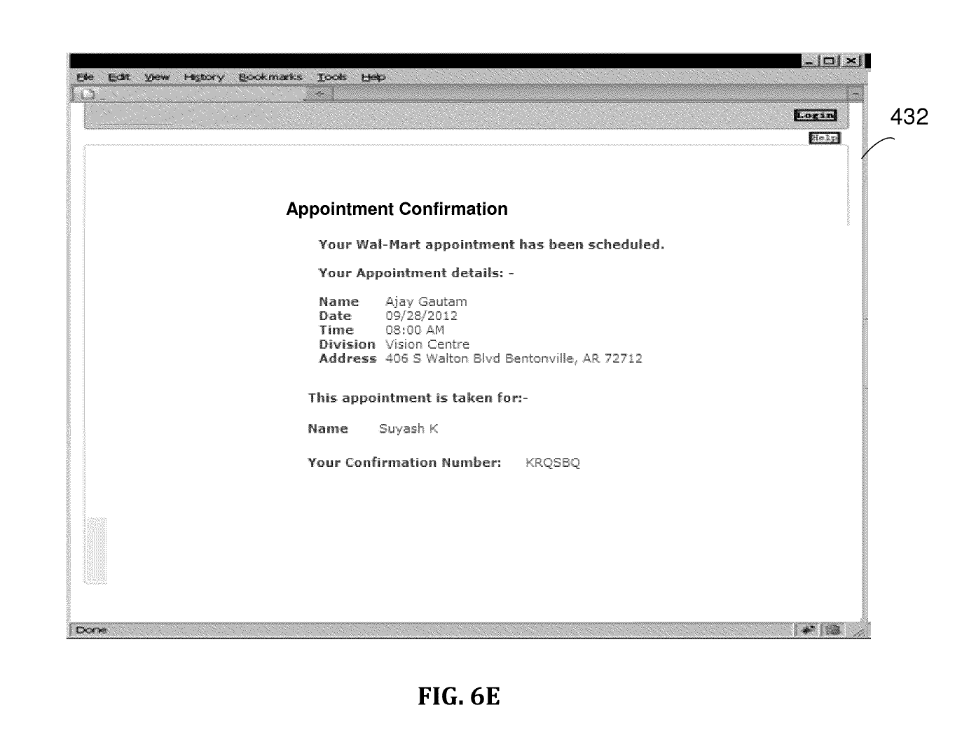

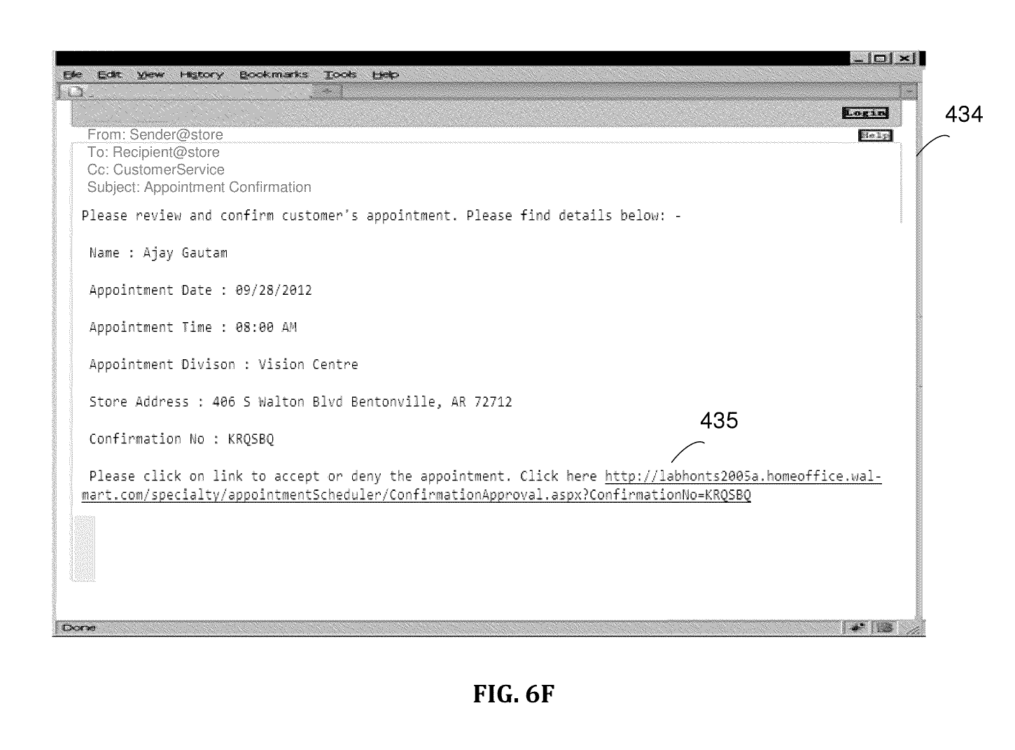

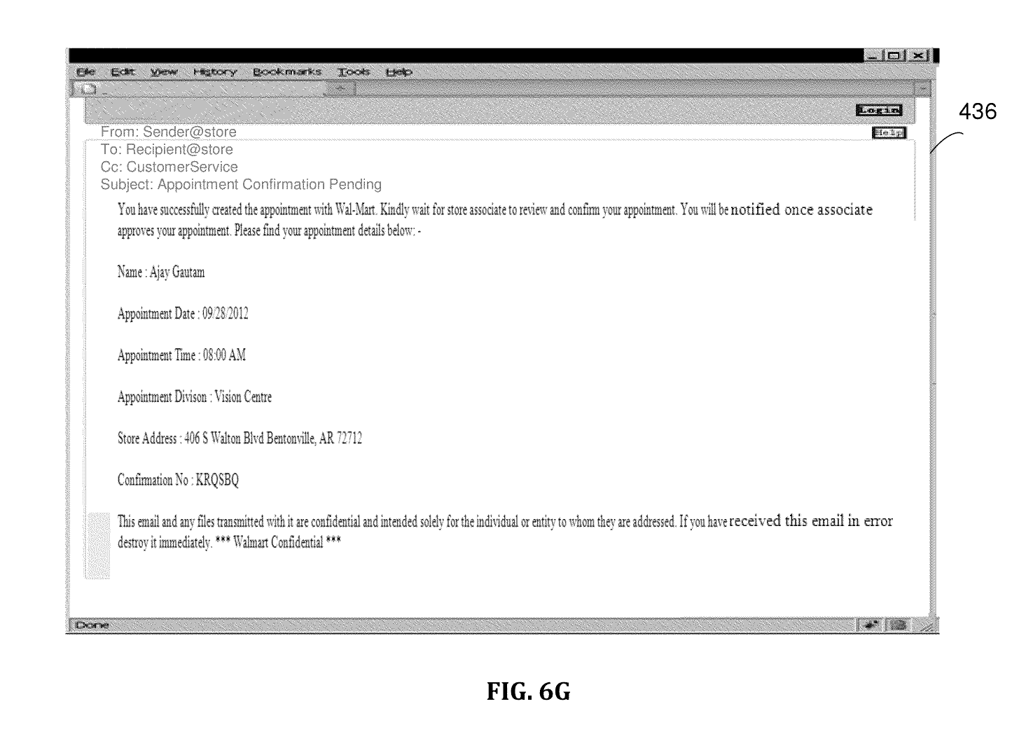

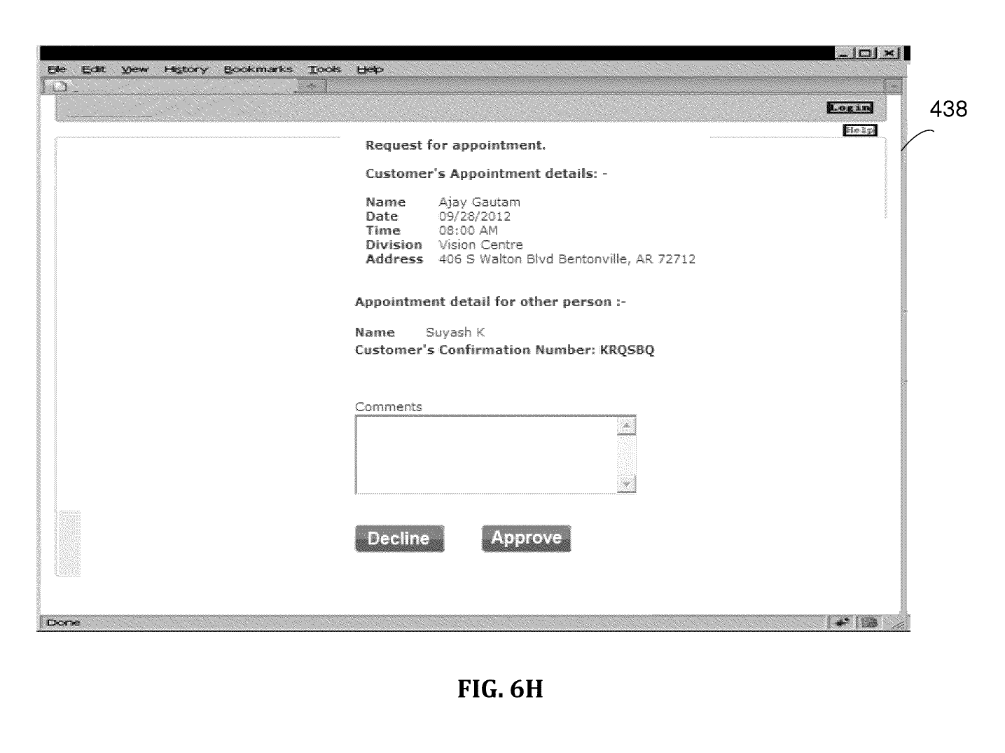

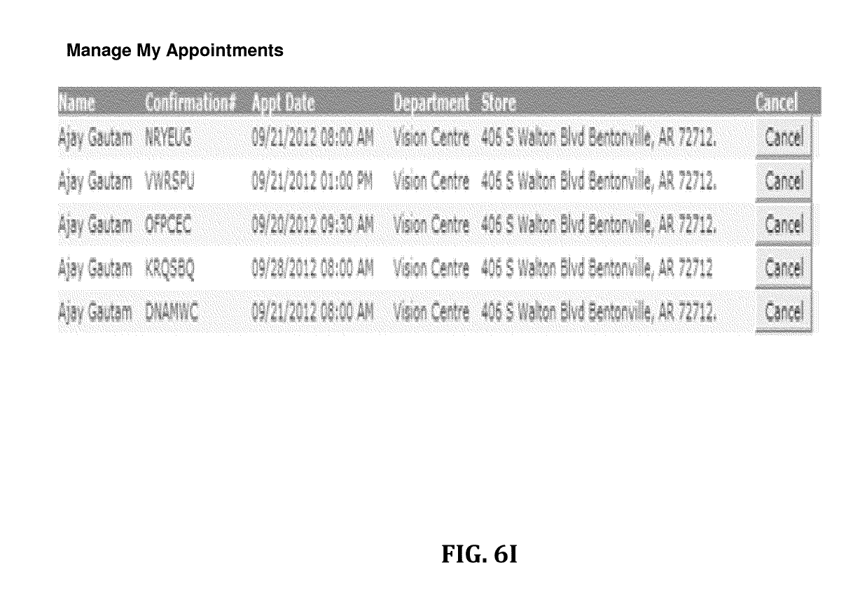

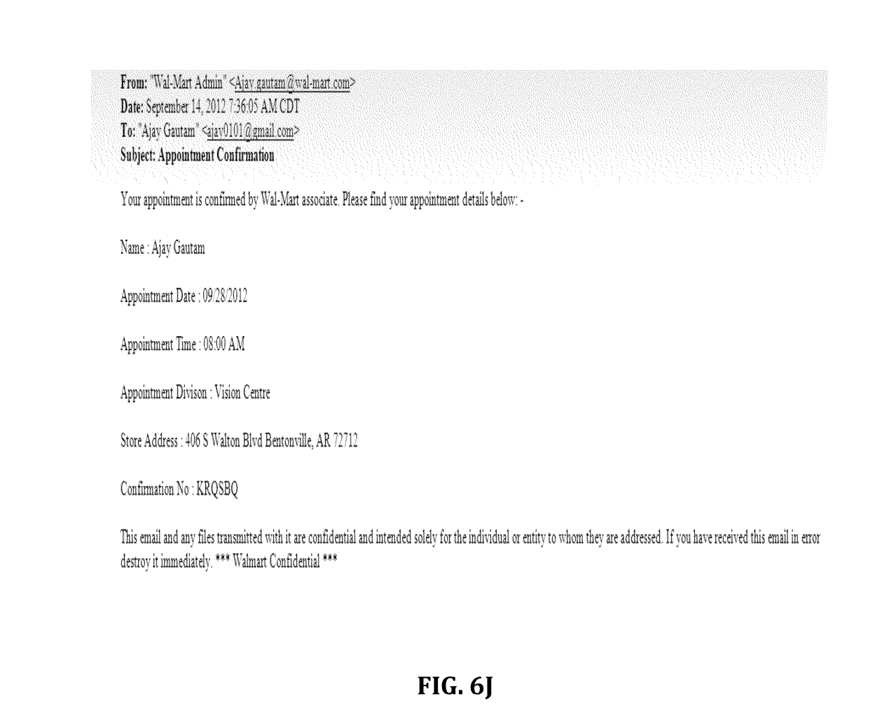

At block 106, the user 12 can schedule at least one appointment from the scheduling window at the user interface 52. Here, the user can enter a date, time, or related information for scheduling the appointment, for example, shown at FIG. 6C. The information input to the scheduling window by the user can be processed by the scheduler 26 and/or stored at a database for future retrieval. In an embodiment, the user 12 can reschedule an appointment. In another embodiment, the user 12 can cancel an appointment. An appointment can be scheduled, rescheduled, or canceled at any service area 40 from the main website 42, or from a homepage or other webpage related to a store location 30 at which the corresponding service area 40 is located. Here, the main website 42 can include hyperlinks or the like to the other websites or webpages related to the store locations 30.

At block 108, a confirmation can be generated by the appointment scheduler 26. The confirmation can be provided to the user 12 in the form of an email message, text message, automated voice message, or other form of communication. The confirmation can include the name of the scheduling party, the date, time, and location of the appointment, and other relevant appointment details, for example, shown at the appointment confirmation screen 432 of FIG. 6E. A copy of the confirmation can be electronically transmitted, for example, to a store associate, the provider of the service, or other interested party. The email addresses, phone numbers, or other contact information of the recipients of the confirmation can be provided at a list or table at the appointment scheduler 26. A lookup of the list or table can be performed to identify the recipients of the confirmation.

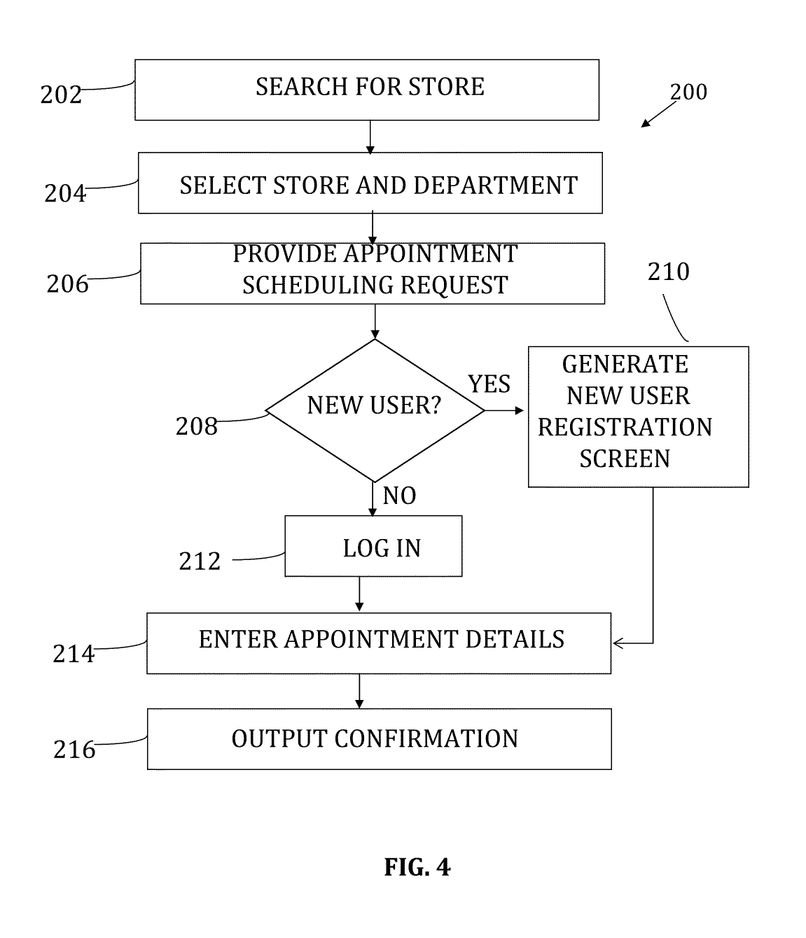

FIG. 4 is a method 200 for online appointment scheduling, in accordance with another embodiment. In describing the method 200, reference is made to FIGS. 1-3. Some or all of the method 200 can be performed at the computer system 20, a user electronic device 12, and/or computers at the store locations 30, for example, governed by instructions that are stored in the memory 24 of the computer system 20 and executed by a processor 22 of the computer system 20.

At block 202, a computer user 12 can search for a particular store from a main website 42 having a homepage corresponding to a retail establishment such as a department store corporate headquarters, a shopping mall, or other business entity owning or otherwise managing a plurality of stores at different locations.

For example, referring to FIG. 6A, a user can use a web browser displayed at a computer screen to present a homepage 442 of a superstore. The homepage 442 includes a store locator, for example, a store finder button 404, and an appointment schedule button 406. When the store finder button 404 is selected, a window (not shown) can be displayed that prompts the user to enter a name, zipcode, or other store identifier which can be used to determine a store that is local, or otherwise of interest, to the user. Accordingly, a list of stores, or no stores, may be displayed, for example, the list of stores 414 illustrated at FIG. 6B. Alternatively, a user can search for a store by selecting the appointment schedule button 406.

The homepage 442 can include a departments field 402, which provides a list of service areas 40, for example, departments offered by one or more stores of the retail establishment.

At block 204, a store can be selected. A store department or sub-organization at the selected store can also be selected.

At block 206, an appointment scheduling request can be provided by the user. A user can request an appointment in a manner that is the same as or similar to that described at block 106 above. For example, referring again to FIG. 6B, a user can select Store A from the list 414. As shown in FIG. 6C, one or more appointment scheduling windows, including but not limited to a division selection window 422, an appointment date window 424, and an appointment time window 426 can be displayed, permitting the user to schedule an appointment at the desired store department, for example, a vision center, and to select the date and time of the appointment.

At decision diamond 208, a determination is made whether the person scheduling the appointment is a new user. If a new user is determined, then the method 200 proceeds to block 210, where a new user registration screen is generated and presented to the user electronic device 12, for example, a desktop computer, a smartphone, or the like. An example of a new user registration screen 430 is shown at FIG. 6D. After a new user enters the registration information at the new user registration screen 430, the information can be stored at a storage device, for example, a database, and can be processed by the appointment scheduler 26 and/or other store-related processor. Here, an account can be established for the new user, whereby, for example, a marketing engine can process the registration information for the purpose of sending coupons, flyers, or the like to the address identified at the new user registration screen.

Returning again to the decision diamond 208, if a determination is made that person scheduling the appointment has an existing account with the website, then the method 200 can proceed to block 212, where the user receives a request to log into the account using existing credentials, e.g., username and password.

Although FIG. 4 refers to an appointment scheduling request being determining whether the person scheduling the appointment is a new user, in other embodiments, the appointment scheduling request only after the new user registration process is completed, or after an existing user has logged into the website with a username, password, or other credentials.

At block 214, appointment details can be entered to the appointment scheduler 26. In an embodiment, appointment details can be automatically provided from user account information, for example, shown in FIG. 6D. Other appointment details can include, but not limited to, personal information, reason for the appointment, background information, and so on. Appointment details can pertain to the user 12, or account owner. Alternatively, the user 12 can schedule an appointment, and enter appointment details, on behalf of another person. After the user enters the appointment details at the user computer 12, other requests can be displayed. For example, a Health Insurance Portability and Accountability Act of 1996 (HIPPA) Notice of Privacy Practices that is well-known to those of ordinary skill in the art can be displayed, with a request that the user acknowledge that the HIPPA Notice has been read and understood by the user.

At block 216, an acceptance of the appointment scheduling request can be processed. Here, a confirmation can be output that the appointment is scheduled. The confirmation can be provided to the user 12 in the form of an email message, text message, automated voice message, or other form of communication. The confirmation can include the name of the scheduling party, the date, time, and location of the appointment, and other relevant appointment details, for example, shown at the appointment confirmation screen 432 of FIG. 6E. A copy of the confirmation can be electronically transmitted, for example, to a store associate, the provider of the service, or other interested party. The email addresses, phone numbers, or other contact information of the recipients of the confirmation can be provided at a list or table at the appointment scheduler 26. A lookup of the list or table can be performed to identify the recipients of the confirmation.

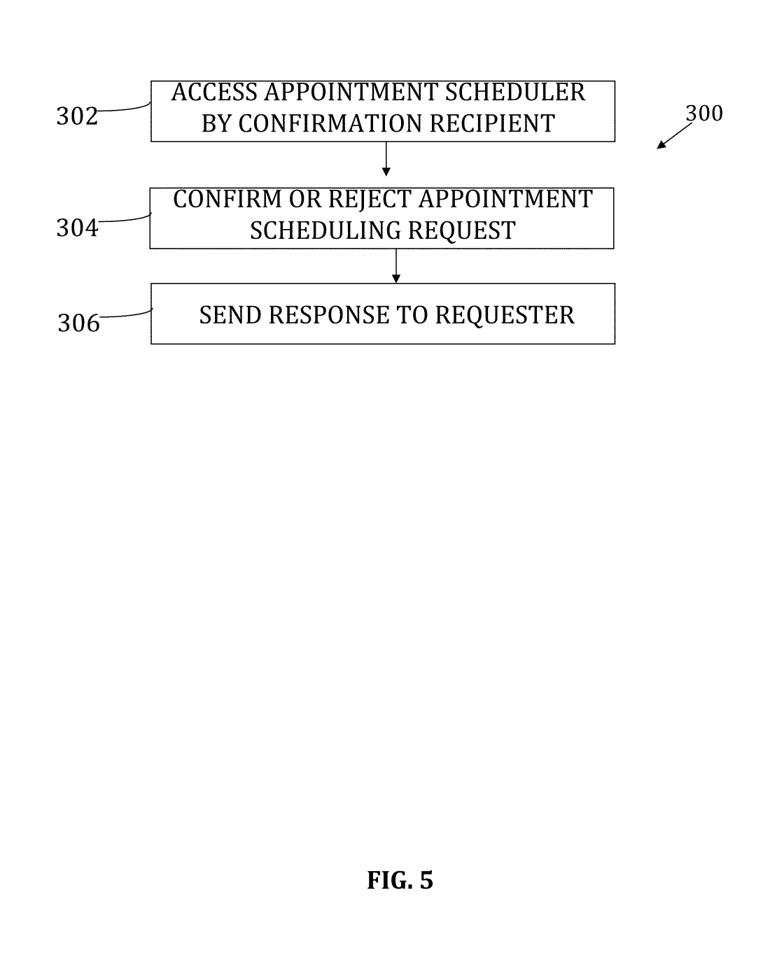

FIG. 5 is a method 300 for processing an appointment request, in accordance with an embodiment. In describing the method 300, reference is made to FIGS. 1-4. Some or all of the method 300 can be performed at the computer system 20, a user computer or other electronic device 12, and/or computers at the store locations 30, for example, governed by instructions that are stored in the memory 24 of the computer system 20 and executed by a processor 22 of the computer system 20. In an embodiment, the method 300 is performed after block 214 and can replace block 216 of method 200 described herein.

At block 302, the recipient of the confirmation request accesses the appointment scheduler 26 by logging into the computer system 20, e.g., entering a username, password, and so on. The recipient can be an associate or representative at the store location 30 responsible for scheduling appointments at the service areas 40 at the store location 30, and authorized to make decisions regarding whether appointment requests are accepted or denied. The appointment scheduler 26 includes a processor that receives from an appointment decision maker appointment scheduling requests, and outputs responses, i.e., confirmations, denials, made by the appointment decision maker.

At block 304, the recipient of the confirmation request can confirm or reject the appointment scheduling request. At block 306, a confirmation or rejection of the appointment scheduling request can be output to the user computer 12, or to the electronic device of a requester of the appointment, for example, as shown at FIG. 6F, sent as an email message 434. In this example, the email message 434 can include a link 435, which when executed can display a window or the like for the recipient to confirm or reject the appointment scheduling request, for example, the appointment scheduling request response window 438 shown at FIG. 6H.

In addition, or alternatively, the user generating the appointment request can receive an acknowledgement, for example, as shown in FIG. 6G The acknowledgement can indicate that the appointment request is being processed, but an actual appointment is scheduled subject to approval by an appropriate party, for example, the recipient receiving the request at FIG. 6F.

In an embodiment, the appointment scheduler 26 can include a scheduling manager, for example, shown at FIG. 6I. The scheduling manager can display a list of confirmed appointments, along with other information including but not limited to user identifications, confirmation numbers, appointment dates and times, and appointment locations.

The foregoing description of the preferred embodiments of the invention has been presented for purposes of illustration and description only. It is not intended to be exhaustive nor to limit the invention to the precise form disclosed; and obviously many modifications and variations are possible in light of the above teaching. For instance, the order of actions during registration and maintenance by the shopper or the charity can vary without effecting the final results of providing goods for purchase and donation to selected charitable organizations. Such modifications and variations that may be apparent to a person skilled in the art are intended to be included within the scope of this invention as defined by the accompanying claims.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific embodiments, it should be understood by those skilled in the art that various changes in form and detail may be made therein without departing from the spirit and scope of the invention.

What is claimed is:

1. A method for online appointment scheduling, comprising:
searching, at a central online application presented at an electronic display, for a store location of a plurality of store locations, wherein the plurality of store locations are part of a retail establishment that presents information related to the store locations from the central online application;
selecting, at the central online application of the electronic display, the store location;
processing, by an appointment scheduler in communication with the central online application, an appointment scheduling request corresponding to the store location that is submitted to the central online application; and
generating a response to the appointment scheduling request.

2. The method of claim 1, wherein a sub-entity of the retail establishment is at the store location, and wherein the appointment scheduling request includes a request for an appointment at the sub-entity.

3. The method of claim 2, wherein the sub-entity includes at least one of a store, an office, a department, a branch, a division, a region, a product area, or a service area.

4. The method of claim 1, wherein the central online application presents at the electronic display a homepage of the retail establishment.

5. The method of claim 4, wherein the homepage includes links to information corresponding to the plurality of store locations.

6. The method of claim 4, wherein the central online application includes a website.

7. The method of claim 1, wherein at least one of the central online application or the appointment scheduler displays data at the electronic display via a web browser or a mobile application.

8. The method of claim 1, wherein appointment scheduling request can be provided by a person to attend the appointment, or by a person other than the person to attend the appointment.

9. The method of claim 1, wherein the appointment scheduling request includes at least one of scheduling an appointment, rescheduling an appointment, or cancelling an appointment.

10. The method of claim 1, wherein the appointment scheduler processes a plurality of appointment scheduling requests corresponding to a plurality of sub-organizations at the store location.

11. The method of claim 1d, wherein the plurality of sub-organizations include at least one stores, offices, departments, branches, divisions, product areas, service areas, regions, or a combination thereof.

12. The method of claim 1, wherein the appointment scheduler processes a plurality of appointment scheduling requests corresponding to the plurality of store locations.

13. The method of claim 1, further comprising:
determining whether a person submitting the appointment scheduling request to the appointment scheduler is a new user of the central online application; and
generating a new user registration screen in response to a determination that the person submitting the appointment scheduling request to the appointment scheduler is a new user of the central online application.

14. The method of claim 1, wherein the appointment scheduler is integrated with the central online application.

15. The method of claim 1, further comprising:
receiving, by an appointment decision maker, the appointment scheduling request; and
generating, by the appointment decision maker, the response, the response including a confirmation or a rejection of the appointment scheduling request.

16. The method of claim 1, further comprising:
selecting the store location from a store locator at the central online application.

17. An online appointment scheduler, comprising:
a processor that communicates with a central online application presented at an electronic display and that processes an appointment scheduling request corresponding to a store location of a plurality of store locations that are part of a retail establishment; and
a processor that generates a response to the appointment scheduling request.

18. The online appointment scheduler of claim 17, wherein the appointment scheduling request includes at least one of scheduling an appointment, rescheduling an appointment, or cancelling an appointment.

19. The online appointment scheduler of claim 17, further comprising
a processor that receiving from an appointment decision maker the appointment scheduling request that outputs by appointment decision maker's response to the electronic display.

20. A computer program product for online appointment scheduling, the computer program product comprising:
a computer readable storage medium having computer readable program code embodied therewith, the computer readable program code comprising:
computer readable program code configured to search, at a central online application presented at an electronic display, for a store location of a plurality of store locations, wherein the plurality of store locations are part of a retail establishment that presents information related to the store locations from the central online application;
computer readable program code configured to process an appointment scheduling request corresponding to the store location that is submitted to the central online application; and
computer readable program code configured to generate a response to the appointment scheduling request.
